(19) United States
(12) Patent Application Publication
(10) Pub. No.: US 2004/0155625 A1
(43) Pub. Date: Aug. 12, 2004

(54) Two cordless activating chargers actuating one another about vehicles and performing the activation of other devices also

(76) Inventor: Herbert R. Floyd, New York, NY (US)

Correspondence Address: HERBERT R. FLOYD, P.O. BOX 286-779, N.Y.C., NY, 10128, US

(21) Appl. No.: 10/719,839

(22) Filed: Nov. 22, 2003

Related U.S. Application Data
(63) Continuation-in-part of application No. 09/503,919, filed on Feb. 11, 2000, now abandoned.
Application No. 09/503,919 is a continuation-in-part of application No. 08/980,485, filed on Nov. 28, 1997, now abandoned.
Application No. 09/503,919 is a continuation-in-part of application No. 08/390,484, filed on Feb. 17, 1995, now abandoned.

(51) Int. Cl. H02J 7/00

(52) U.S. Cl. 320/104

(57) ABSTRACT

Dual cordless battery activating chargers activating their batteries via a vehicle, other vehicle, and performing the activation of other devices comprises: two 2.5 A chargers each having 96 percent efficiency, an external power switch, a surface for placement of a user's finger for actuating the switch and the chargers simultaneously. This switch is in a column of the vehicle, also. The chargers further comprises an IC1 for controlling this switch, a charge pump generating a positive gate-drive voltage of the switch, a charging current having a voltage across a 25-Mohma resistor R3, and amplified by an op amp via positive-voltage feedback to IC1, a chip for maintaining the charging current at 2.5 A, a circuit supplying the current to a separate load up to a limit being set via a current-sense transformer T1, and a sense resistor R1. T1 improves efficiency by lowering power dissipation in the resistor R1. This transformer turns ratio (1:70) routs, only 1/70 of the total battery-plus-load current through R1, generating a feedback voltage which enables IC1 to limit the overall current to a level compatible with the external components. While charging this system can activate computers, televisions, air conditioners, electrical ranges, refrigerators and much more. The system does not have to be charged, unless the inductor current exceeds the 100 mV current limit threshold. This causes a high-side latch to reset and turns off a high-side switch.

### CROSS-REFERENCE TO RELATED APPLICATIONS

This application is a continuation-in-part of application Ser. No. 09/503,919, filed on Feb. 11, 2000, now abandoned which is a continuation-in-part of application Ser. No. 08/980,485 filed on Nov. 28, 1997 now abandoned and application Ser. No. 08/390,484 filed on Feb. 17, 1995, now abandoned.

### BACKGROUND OF THE INVENTION

1. Field of the Invention

The present invention relates to energy and specifically to public utilities, vehicles, computers, televisions, refrigerators, electric ranges, air conditioners, motorized-wheelchairs, backup systems for the Patent Office (PTO) even Hospitals, homes, condominiums Banks and Generating Stations or Substations. The above Cordless Activating Energy (CAE), however, can save thousands of dollars yearly in maintenance cost for U.S. organizations. While safety and environmental concerns each of which is an important issue, a CAE Electric Powered Locomotive will provide CAE concerning its load. On earth, only one nation will be generating Giant CAE Systems, namely, THE UNITED STATES OF AMERICA.

2. Description of the Prior Art

Two Cordless Actuating Battery Systems actuating one another, and performing the activation on other devices each of which is a revolutionary 21st. Century reality, such that AMERICA will not have to depend on foreign oil.

### SUMMARY OF THE INVENTION

Accordingly, one object about this present invention is to provide dual cordless activating chargers for vehicles such as, Automobiles, Trucks, tractors, “Motorboats,” ships, Aircrafts, Buses, Motorcycles, Scooters, Forklifts, Electric Jacks, Fire Fighting Apparatuses and Snow Removal Equipment.

Nevertheless, to accomplish the foregoing, and other objects, two cordless battery chargers actuating one another in a vehicle, other vehicles and performing the actuation in other devices comprises: dual conventional battery chargers, a first 2.5 A battery charger defining 96 percent efficiency, a second 2.5 A charger having the 96 percent efficiency also, an external power switch mounted about the first charger for placement of a user's finger, there actuated by depressing a surface of the power switch, thereby activating the chargers simultaneously, and defined on a column of the vehicle also, a buck-mode switching regulator IC1 controlling the external power switch and the IC1 having a charge pump for generating a positive gate-drive voltage of the power switch, a battery charging current having a voltage across a 25-Mohms resistor (R3), and is amplified by an op amp including positive-voltage feedback to the IC1, a chip for maintaining the charging current at 2.5 A, a circuit thereby, supplying the current to a separate load up to a limit set via a current-sense transformer T1, and a sense resistor R1 for improving efficiency, thereby lowering power dissipation in the resistor R1, while charging. The transformer T1 turns ratio (1:70) routes 1/70 via the total battery-plus-load current through the resistor R1 The transformer T1 defining the feedback voltage to enable IC1 to limit the overall current to a level compatible via the external components, which is a 100 mV current-limit.

According to another object regarding the invention, a pair of cordless battery operated actuating chargers activating one another in a vehicle, other vehicles, and thereby performing the activation of many devices comprises: a first DC to AC converter for converting DC current via alternating current, a second DC-AC converter for converting the DC current to the alternating current, a first AC adaptor, thereby coupling the chargers to the converters, a second AC adaptor for joining the chargers to the converters when the chargers defining full charged energy: activating one another about a switch, a first battery cartridge for restoring life about a first battery, a second battery cartridge for restoring the life of a second battery, a six cell feeder for distributing restorable agents to the batteries. The vehicle has a motor mounted adjacent the chargers. The motor having a polarized plug. The chargers performing the activation via the motor, when the plug is connected through the first converter. The chargers performing the activation of the motor and starting the vehicle. The batteries are coupled to an alternator for its belt and pulley to spin 60 cps/60 Hz via the motor. The chargers performing the activation of the motor, and thereby activating one another. The chargers thereby performing the activation of one another when the motor is turned off. The chargers actuate the other vehicles in the air, on the earth and in the water. The chargers performing the activation of the other devices in homes, condominiums, Hospitals, housing developments, Air Ports, offices, and Generating stations or Substations. The chargers actuating computers, televisions, electric ranges, air conditioners, and all portable devices, including refrigerators. The chargers activating a cordless escalator about Air Ports, and Train Stations. The chargers activate snow removal equipment, fire fighting equipment and motorized wheelchairs. The chargers, thereby performing the activation of satellites, and of systems for interception of missals. The chargers connected through series-parallel are equal to the sum of the power values consumed via each load. The cartridges have a LED, and resistors to thereby activate a first and second gear motor, the life is restored when the gear motors free the agents. The chargers activating backup systems for preventing the loss of data regarding computers.

### BRIEF DESCRIPTION OF THE DRAWINGS

Further objects and advantages given herewith concerning the present invention will become apparent via the drawings, and the preferred embodiments concerning the description herein.

FIG. 1 is a view of two cordless activating chargers actuating one another, and activating other devices as well;

FIG. 2 is a block diagram simplifying the first 2.5 A cordless activating charger;

FIG. 3 is a block diagram simplifying the other 2.5 A cordless activating charger;

FIG. 4 is a perspective view of an electric vehicle, and a polarized plug connected to a first converter;

FIG. 5 is a cut surface of a first battery cartridge and its six cell feeder for distributing restorable agents;

FIG. 6 is a cut surface of a second cartridge having its six cell feeder for distributing restorable agents also;

FIGS. 7, 7F 7G, 7H have a block diagram via a light-actuated circuit, a LED 0, a load circuit and an alternator;

FIGS. 8-8G are views about an air conditioner and an electric range connected with the cordless actuating system;

FIG. 9 is a block diagram defining a PWM Controller;

FIGS. 10-10G define a view of a television connected with the charging system, and a block diagram via a Circuit;

FIG. 11 is a view of a computer comprising a printer each of which is connected to the cordless actuating system;

FIGS. 12-12G are block diagrams of a modal including its switch and the activating system.

### DESCRIPTION OF THE PREFERRED EMBODIMENTS

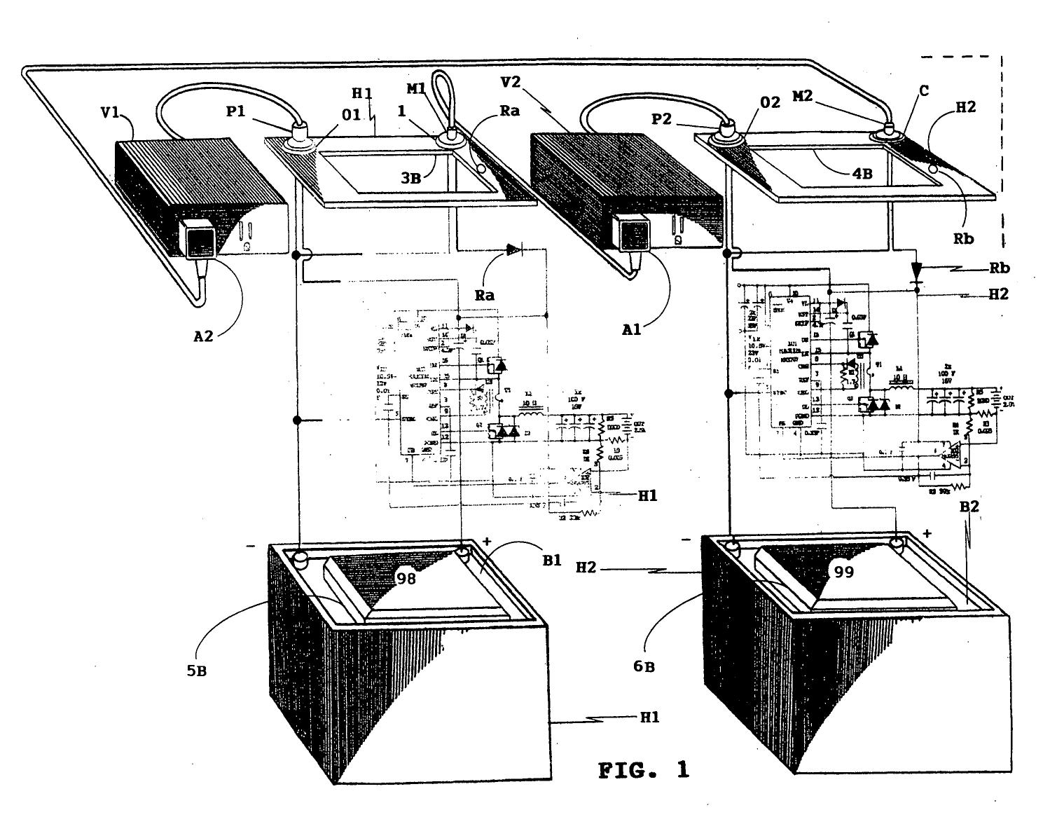

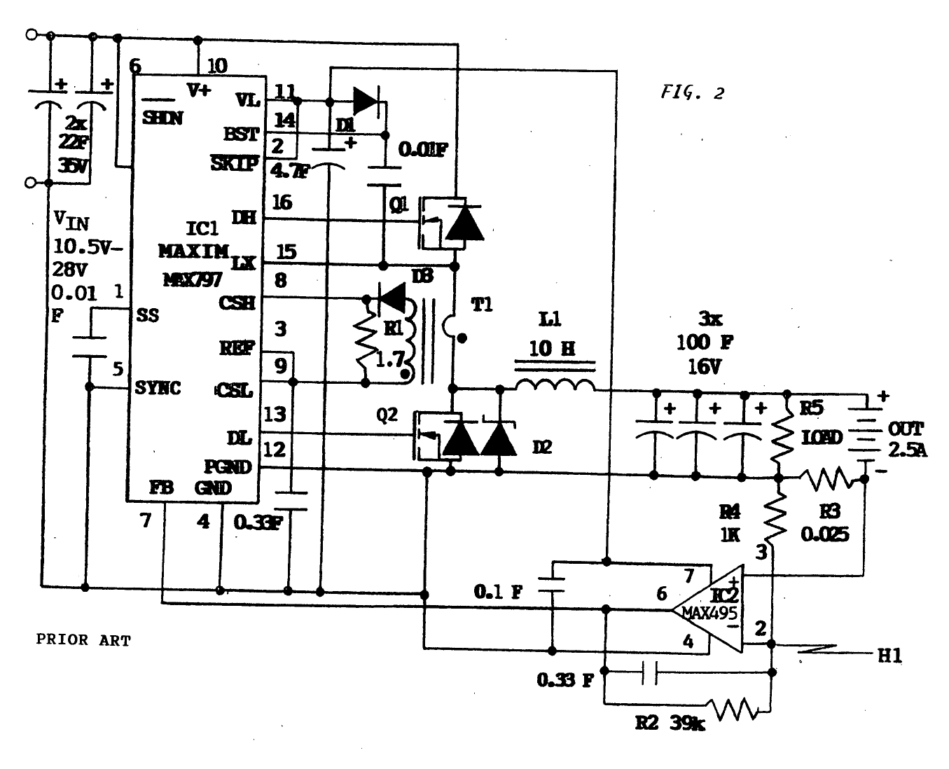

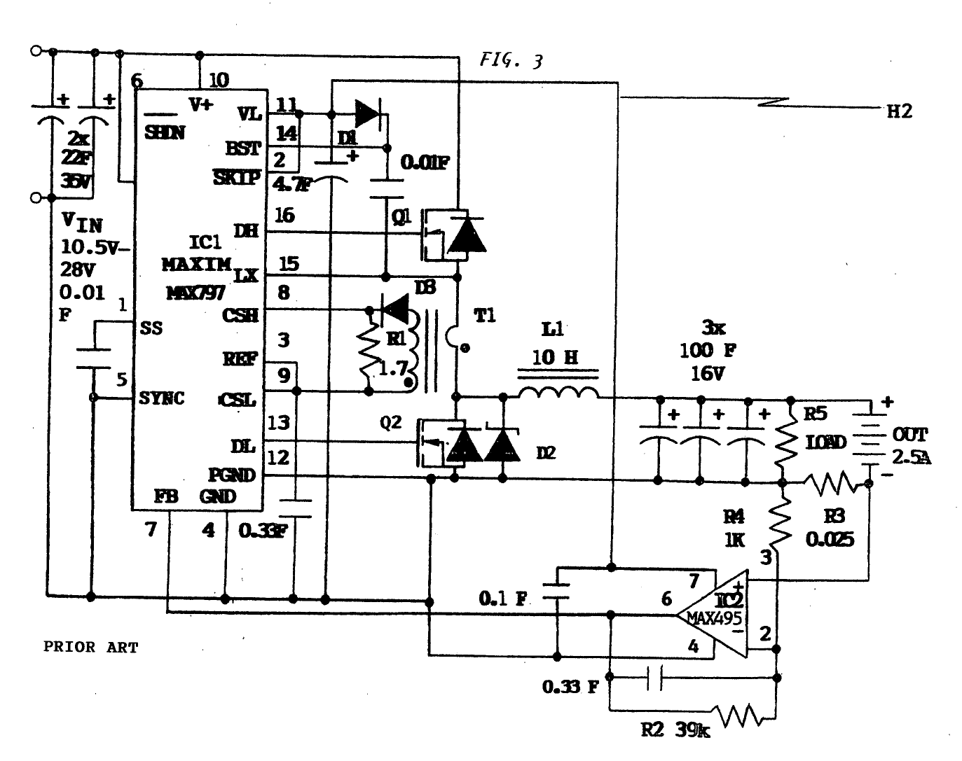

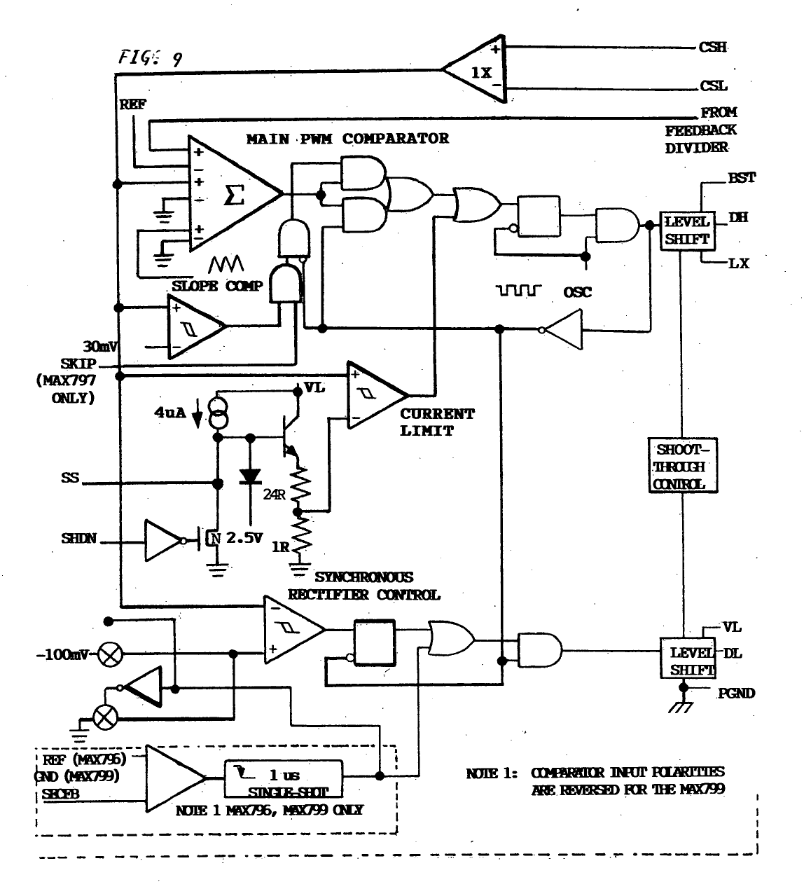

Referring to FIG. 1, dual conventional 2.5-A battery chargers H1 to H2 charges one another, as two LEDs Ra and Rb emit light about the chargers H1-H2. The charger H1 defines a battery B1, and the charger H2 includes a battery B2 about the 2.5 A activating circuits H1-H2 shown in FIGS. 2-3. The chargers H1-H2 delvers 2.5 A with efficiency, as high, as 96 percent, since battery chargers are usually designed without regard for efficiency, seeing that the heat generated by low efficiency chargers will present a problem. A heat current-mode P.W.M. controller is a multi-input open-loop comparator that sums three signals: output voltage error signal via the reference voltage, current-sense signal, and slope compensation ramp (FIG. 9). The PWM controller is a direct summing, thereby lacking a traditional error amplifier, and the phase shift associated with it. The direct summing configuration, however, approaches the ideal of cycle-by-cycle control over the output voltage.

Under heavy loads, this controller operates via full PWM mode. Thus, each pulse from an oscillator sets the main PWM latch, which turns on the high-side switch for a period, thereby, determined via the duty factor (approximately VOUT/VIN). Since the high-switch turns off, a synchronous rectifier latch is now set. 60 ns later the low-side switch turns on, and stays on until the beginning of the next clock cycle (via continuous mode), or until the inductor current crosses zero (in discontinuous mode). Under fault conditions, where the inductor current thereby exceeds the 100 mV current-limit threshold, the high-side latch resets, whereby the high-side switch turns off. Since one charger H1 can charge a battery of one to six cells, while operating from a vehicle battery, these chargers H1-H2 can charge their batteries B1-B2, while operating from an electric vehicle and not exceed the 100 mV.

Further, the chargers H1-H2 define a DC-AC converter V1, which has a plug P1 to fit an output outlet O1 about the charger H1. A DC-AC converter V2 has a plug P2 in an output outlet O2 upon the charger H2. This system causes each 12 V battery B1 to B2 to charge one another by a battery-charging current, which develops a voltage across a 25-Mohms resistor R3 (FIGS. 2-3). Now, an AC adapter A1 fits a charger jack 1 by a mail plug M1 upon the charger H1. As the adapter portion A1 plugs in the converter V2, the charger H2 now outputs current that chargers the battery B1. This is accomplished, only when an AC adapter A2 fits a charger jack C by use of a plug M2 on the charger H2, since the adapter A2 plugs in the converter V1. As the charger H1 is charging the battery B2, the output outlet O1 upon the charger H1 outputs 12V DC current which the converter V1 converts to alternating current. The current flows through this adapter A2, its lead, and the plug M2 via the charger jack C. This charges the battery B2 whereby, the charger H2 is likewise charging battery B1.

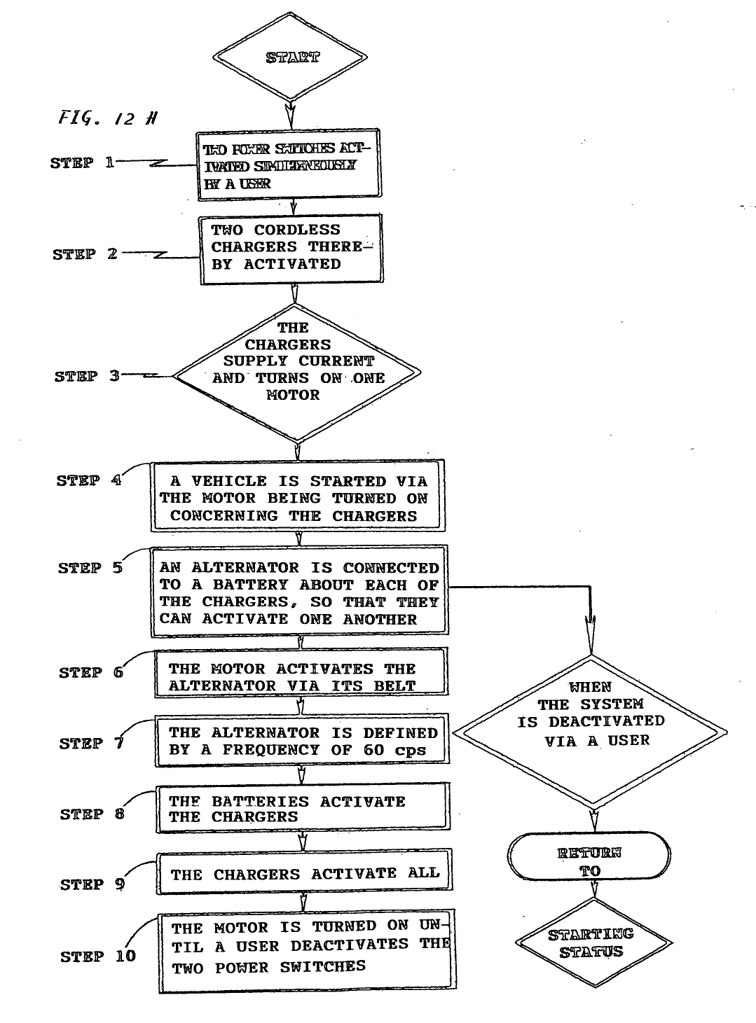

Referring to FIGS. 12-12G, a power switch 7a is seen in FIG. PS for actuating a motor M of a vehicle. A controller 60 in the vehicle has a CPU 90 for activating the switch 7a, when two transistors Q3-Q4 are triggered. A coil of two relays Y and MR each of which is hot, as the transistors Q3-Q4 are triggered. Three coils 44,45,46 of actuators are for turning on the chargers H1 and H2, so that two resistors R6-R7 are provided, and the LEDs Ra-Rb emit light.

Since the switch 7a is coupled to the CPU 90, a user will actuate the switch 7a and at the self same time turn on the chargers H1-H2 simultaneously. Now, this will cause the motor M to be turned on, also, seeing that the transistor Q4 is for actuating the motor M. Besides, the transistor Q4 is engineered to turn on the motor M when the foundation of the transistors Q3-Q4 are, thereby, connected to the output terminals of the CPU 90. The collector of the transistor Q3 is connected to the hot coil of the relay Y, and to a collector bias source Vcc about the CPU 90. The emitter regarding the transistor Q3 is grounded as an end of these coils 44, and 45 of actuators for activating the charger H2 is connected to a lead of the collector bias source Vcc, the other end is thus grounded through the relay Y.

When the transistor Q3 is activated, the coil of the relay Y is hot, such that electric current flows through the coils 44-45, which turns on the charger H2 simultaneously as the switch 7a is activated. The collector of the transistor Q4 is connected to the coil of the relay MR, and to the collector bias source Vcc. The emitter of the transistor Q3 is grounded and one lead of the coil 46 of actuator for causing the motor N to be turned on is coupled to the collector bias source Vcc, while the other leads are grounded using the relay MR. The LEDs Ra-Rb are connected via the collector bias source Vcc, and the other leads are grounded through the relay MR. Since the transistor Q4 is turned on by a user, the coil via the relay MR is hot, so that electric current flows through the coil 46, and the LEDs Ra-Rb. The motor N is now turned on, when the power switch 7a is activated via a legal user, the switch 7a turns off the motor N as it is activated once more by a legal user.

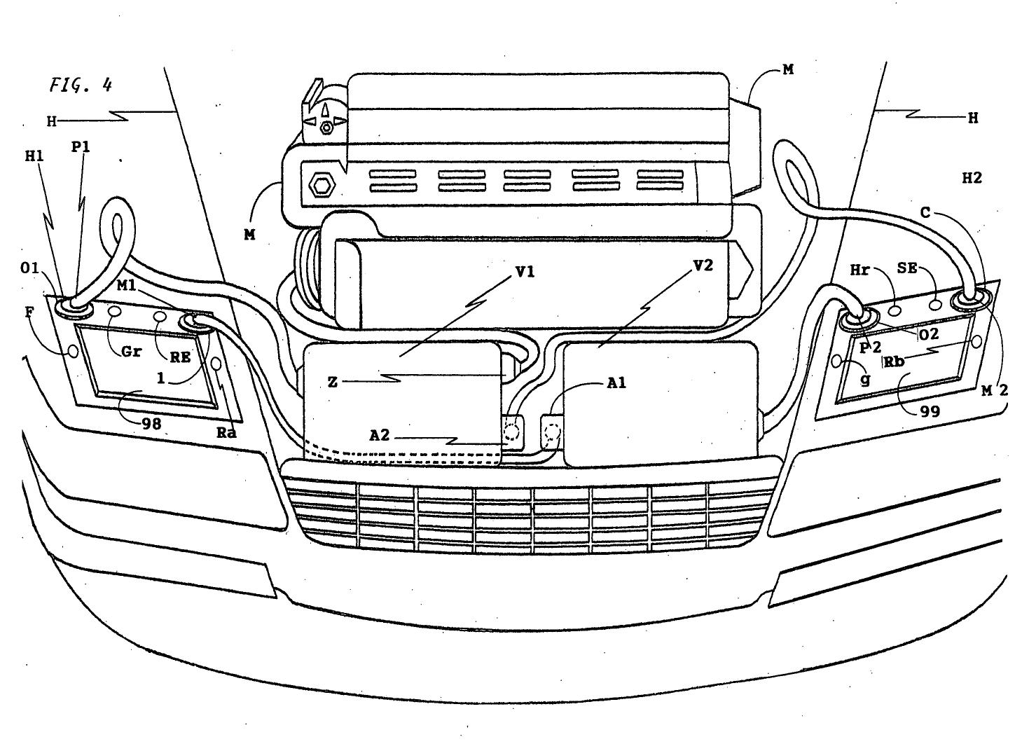

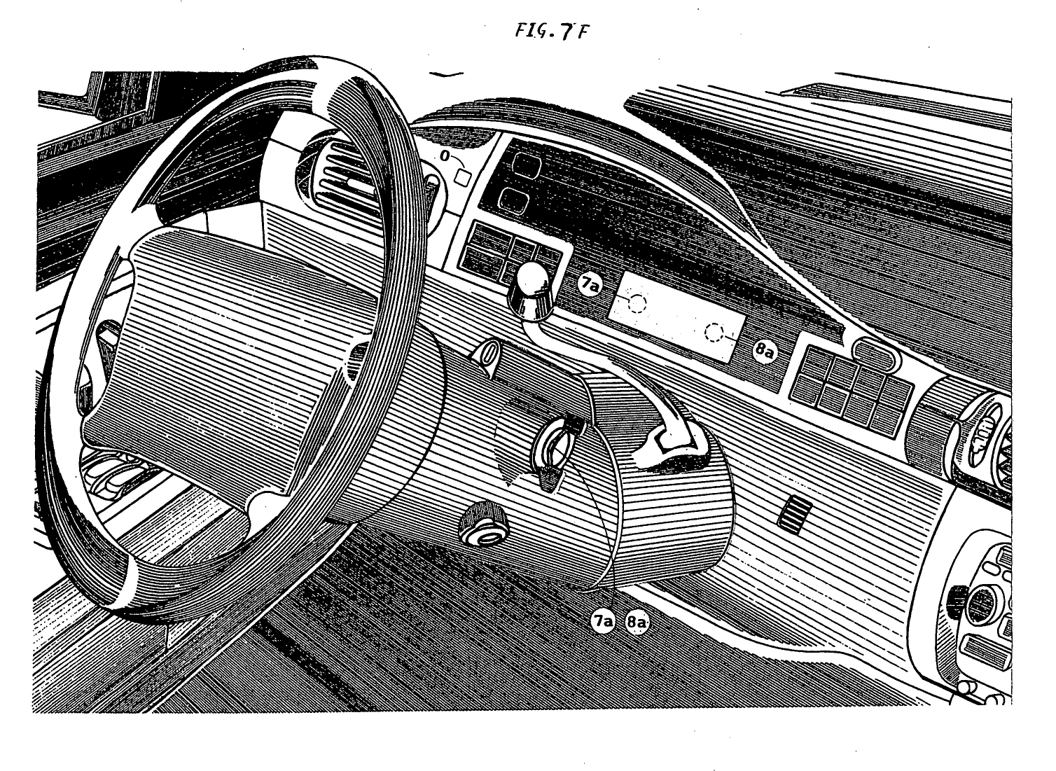

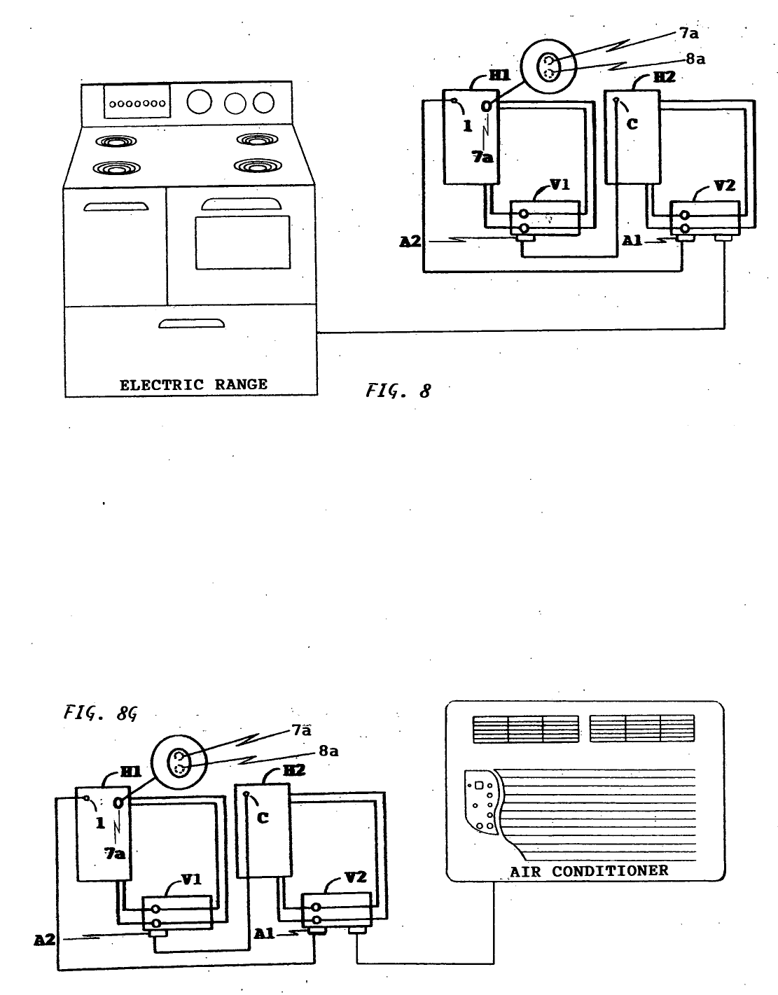

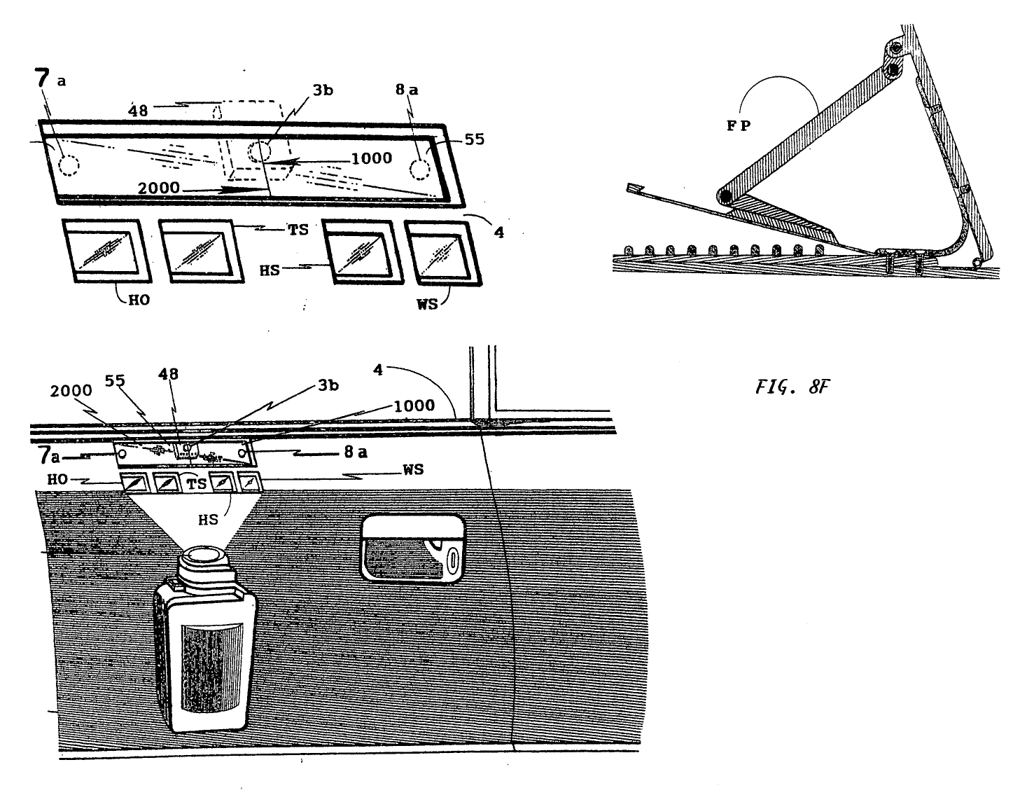

Referring to FIGS. 2, 3, and 4, the activating system is located beneath a hood H of the vehicle. The charger H1, and its battery B1 fit in a battery box B, as the charger H2 and its battery B2 fit a battery box B3. A Polarized plug Z concerning the motor N is plugged in the DC-AC converter V1. Besides, the embodiment about the Cordless Activating System is so that an alternator XX of the vehicle is conventionally coupled about the batteries B1-B2 (FIG. 7H). An alternating voltage reverses its polarity on each alternation and reverses its direction of flow on each alternation. Nonetheless, the frequency via an AC voltage, or current is its number of cycles per second. For example, electricity being generated by public utility companies in the United States incorporate a frequency of 60 cycles per second. The motor M will cause an alternator belt including its pulley to rotate accordingly, regarding the above modification. The alternator XX can supply AC current to the batteries B1-B2, while the chargers H1-H2 are charging one another. Besides, the chargers H1-H2 are defined by the PWM mode. This prevents the chargers H1-H2 from overheating when charging one another, and supplying AC current to a separate load, namely, the motor M. Now the user will not have to charge his/her vehicle, seeing that it is time consuming and annoying. Two large chargers defining two several hundred ton batteries concerning this system can operate accordingly, in Generating Stations for transmitting energy through transmission lines to varies parts of a City. grounded and one lead of the coil 46 of actuator for causing the motor M to be turned on is coupled to the collector bias source Vcc, while the other leads are grounded using the relay MR. The LEDs Ra-Rb are connected via the collector bias source Vcc, and the other leads are grounded through the relay MR. Since the transistor Q4 is turned on by a user, the coil via the relay MR is hot, so that electric current flows through the coil 46, and the LEDs Ra-Rb. The motor M is now turned on, when the power switch 7a is activated via a legal user, the switch 7a turns off the motor M as it is activated once more by a legal user.

Referring to FIGS. 2, 3, and 4, the activating system is located beneath, a hood H of the vehicle. The charger H1, and its battery B1 fit in a battery box B, as the charger H2 and its battery B2 fit a battery box B3. A Polarized plug Z concerning the motor M is plugged in the DC-AC converter Vl. Besides, the embodiment about the Cordless Activating System is so that an alternator XX of the vehicle is conventionally coupled about the batteries B1-B2 (FIG. 7H). An alternating voltage reverses its polarity on each alternation and reverses its direction of flow on each alternation. Nonetheless, the frequency via an AC voltage, or current is its number of cycles per second. For example, electricity being generated by public utility companies in the United States, thus, have a frequency of 60 cycles per second. The motor M will cause an alternator belt including its pulley to rotate accordingly, regarding the above modification. The alternator XX can supply AC current to the batteries B1-B2, while the chargers H1-H2 are charging them. Consequently, these chargers H1-H2 are defined by the PWM mode. This prevents the chargers H1-H2 from overheating when charging one another, and supplying AC current to a separate load, namely, the motor M. Now the user will not have to recharge his/her vehicle as it is time consuming, and a newsiness. Thus, two large chargers having two several hundred ton batteries concerning this system can operate accordingly, in Generating Stations and transmitting energy through transmission lines to varies parts of a City.

Now, referring to FIGS. 2-3, The MAX796/MAX797/MA799 Step-Down Controllers with respect to the present invention, have the Synchronous Rectifier for CPU Power, and defined by single or dual outputs in battery-powered systems. IC1 is a buck-mode switching regulator of which controls the external power switch 7a and the synchronous rectifier. Now the rectifier diode in coupled-inductor applications must withstand high flyback voltages better than 60V that usually rules out most Schottky rectifiers. Common silicon rectifiers such as the 1N4001 are prohibited also, since they are far too slow. This causes fast silicon rectifiers, such as the MURS120 the only choice.

Since IC1 comprises a charge pump for generating the positive gate-drive voltage by way of 7a, the battery-charging current develops a voltage across this 25-Mohms resistor (R3) that is amplified by the op amp, and thereby presented, as positive-voltage feedback to IC1. This feedback thereby, enables this chip to maintain the charging current, thus, at 2.5 A. While charging, the circuit can, also, supply current to a separate load up to a limit set by current-sense transformer T1, and sense resistor R1. T1 improves efficiency by lowering power dissipation in R1. This transformer T1, now, turns ratio (1:70) routes only 1/70 about the total battery-plus-load current about R1, thus creating a feedback voltage enabling IC1 to limit the overall current however to a level compatible with the external components.

Buck-plus-flyback applications, are sometimes called “coupled-inductor” topologies, however need a transformer in order to generate multiple output voltages. The basic electrical design is a simple task via calculating turns ratios, and adding the power delivered to the secondary in order to, thus calculate the current-sense resistor and primary inductance. However, extremes of low input-output differentials, widely different output loading levels and high turns ratios can thus, complicate the design due to parasitic transformer parameters, such as inter-winding capacitance, and secondary resistance. Power from the main and secondary outputs thus, is lumped together to obtain an equivalent current referred, however to the main output voltage. Set the value about the current-sense resistor at 80 mV/TOTAL.

PTOTAL=the sum regarding the output power from all outputs TOTAL=PTOTAL/V OUT=the equivalent output current referred to V OUT

$$L ( primary ) = \frac{V OUT ( V N ( MAX ) - V OUT )}{V N ( MAX ) \times f \times TOTAL \times LIR}$$

$$Turns Ratio N = \frac{V SEC + V FWD}{V OUT ( MIN ) + V RECT + VSENSE}$$

where: V SEC is the minimum required rectified secondary-output voltage

V FWD is the forward drop across the secondary rectifier

V OUT(MIN) is the minimum value of the main output voltage

V RECT is the on-state voltage drop across the synchronbus-rectifier MOSFET

V sense is the voltage drop across the sense resistor

In positive-output (MAX796) applications, the transformer secondary return is often referred to the main output voltage rather than to ground in order to thereby reduce the needed turns ratio. Now in this case, the main output voltage must first be subtracted from the secondary voltage thus to obtain V SEC.

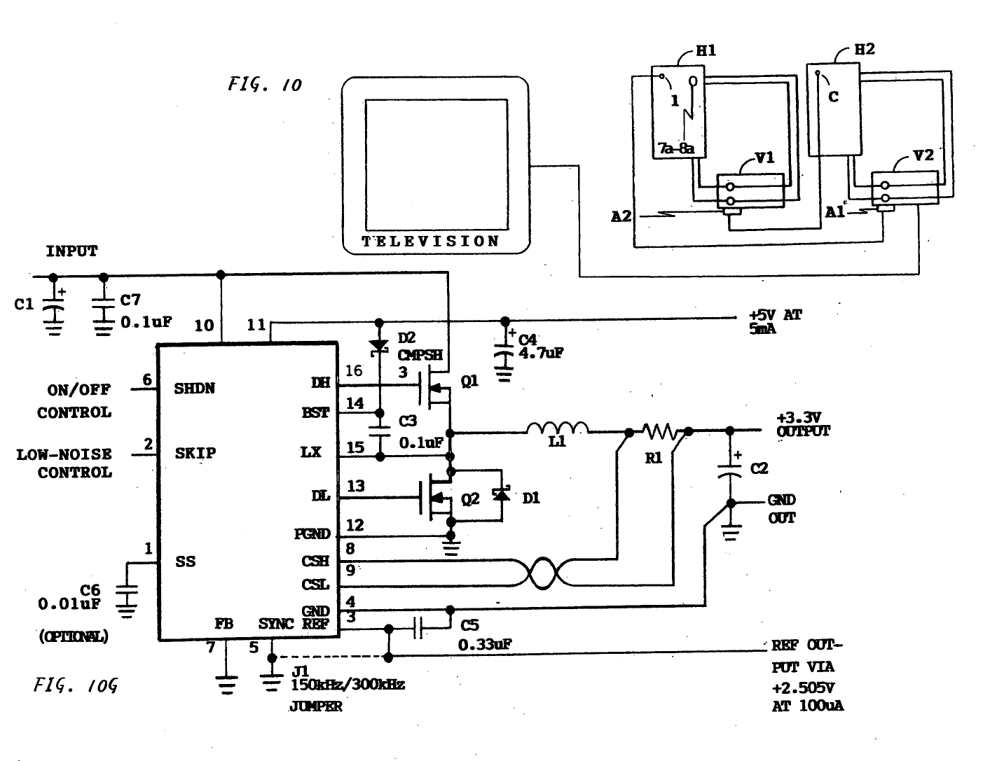

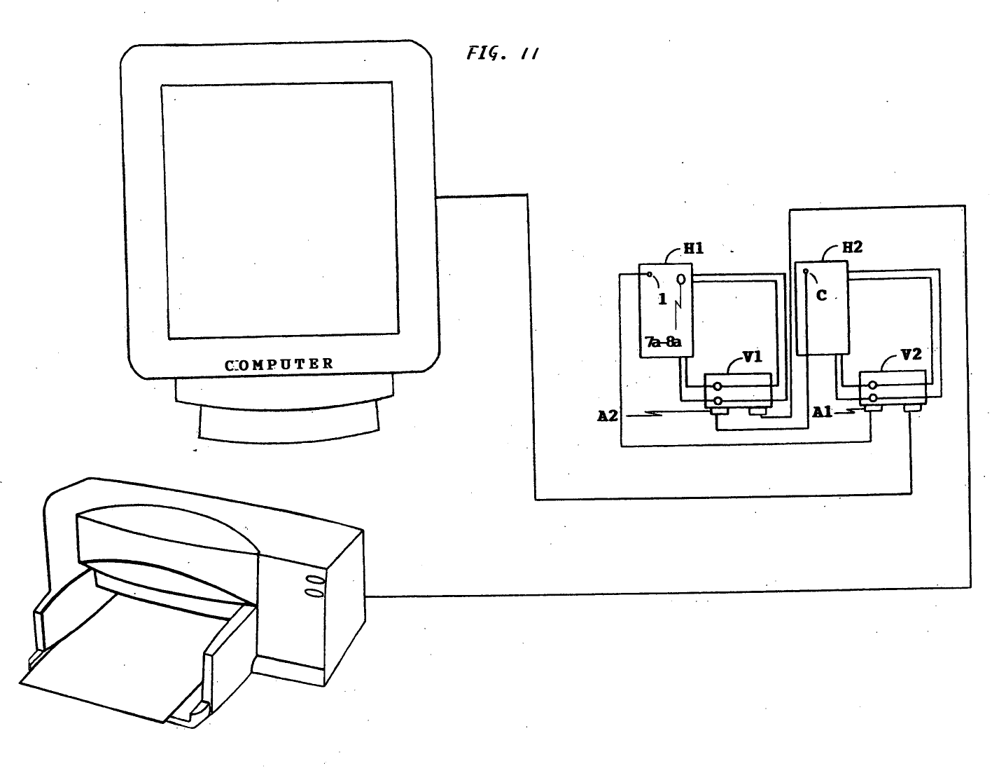

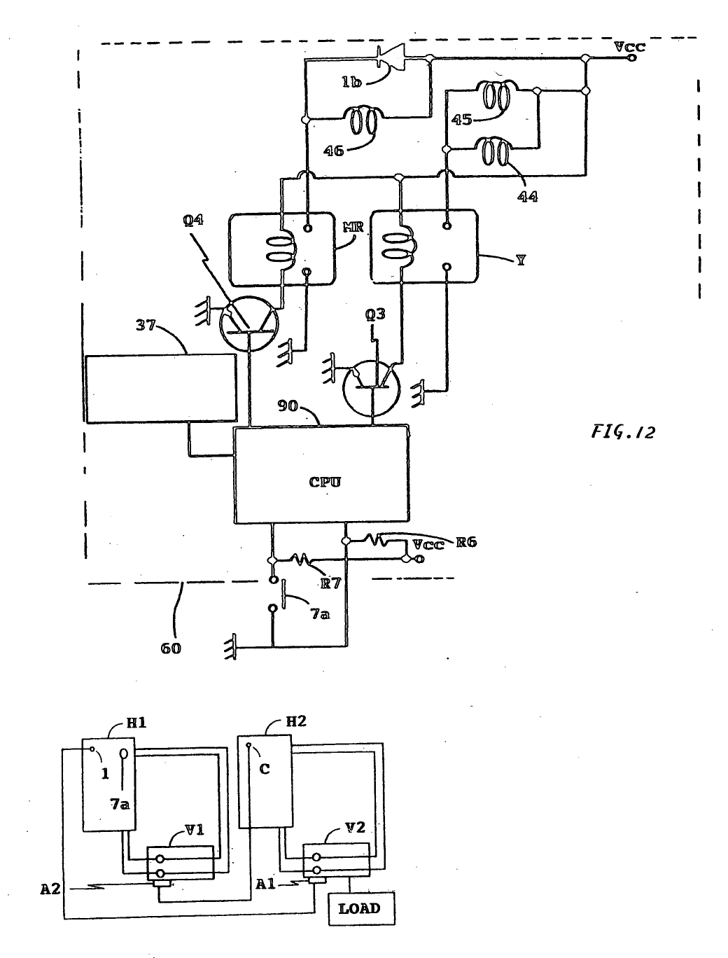

As a rule, the basic MAX.797 single-output 3.3V buck converter (FIG. 10G) is designed to accommodate a wide range of applications with inputs up to 28V. While, each of these circuits is rated for a continuous load current at TA=+85C, varies applications can withstand a continuous output short-circuit to ground. Heavy-load efficiency MAX492/MAX494/MAX495 can drive capacitive loads in excess of 1000 pF, however, under certain conditions (FIG. 7G). When driving capacitive loads, the greatest potential for instability, thus, occurs, when the op amp is sourcing approximately 100 uA. Even, with this system, stability is maintained with up to 400 pF output capacitance. Now, if the output sources either more or less current, stability is increased. These devices perform well with a 1000 pF pure capacitive load, nonetheless, to increase stability, while driving large capacitive loads with respect to 10,000 pF add an output isolation resistor.

Output loading and stability when driving heavy capacitive loads is another key advantage about comparable CMOS rail to rail op amps. Because the MAX492/MAX494/MAX495 have excellent stability, no isolation resistor is required, only in the most demanding applications is it required. The MAX797 is a BICMOS switch-mode power-supply controller designed primarily for buck-topology regulators about battery-powered applications, where high efficiency and low quiescent supply current are critical. The MAX797, also, works well in other topologies such as boost, inverting and CLK due to the flexibility of its floating high-speed gate driver.

Moreover, the internal IC PWM Controller Blocks, and Bias Generator Blocks aren't powered, directly from the battery. Instead, a +5V linear regulator, thus, steps down the battery voltage to supply both the IC internal rail (VLpin), as well as the gate drivers. As the synchronous-switch gate driver is directly powered from +5V VL, the high-side-switch gate driver is indirectly powered from VL with respect to an external diode-capacitor boost circuit. Notwithstanding, an automatic bootstrap circuit turns off the +5V linear regulator, and powers the IC from its output voltage if the output is above 4.5V.

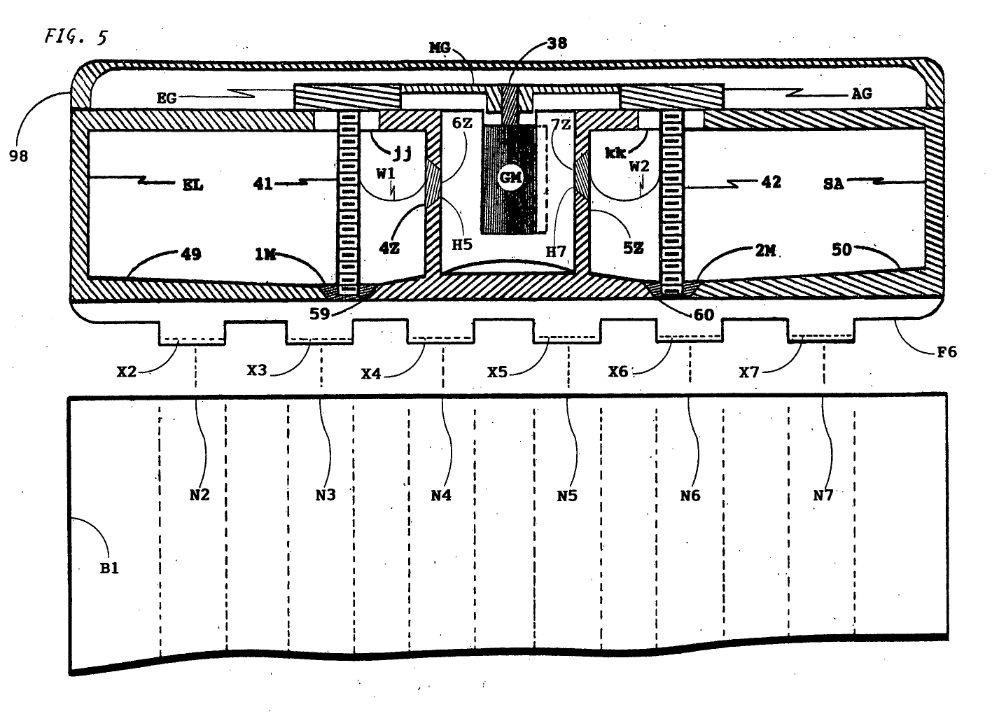

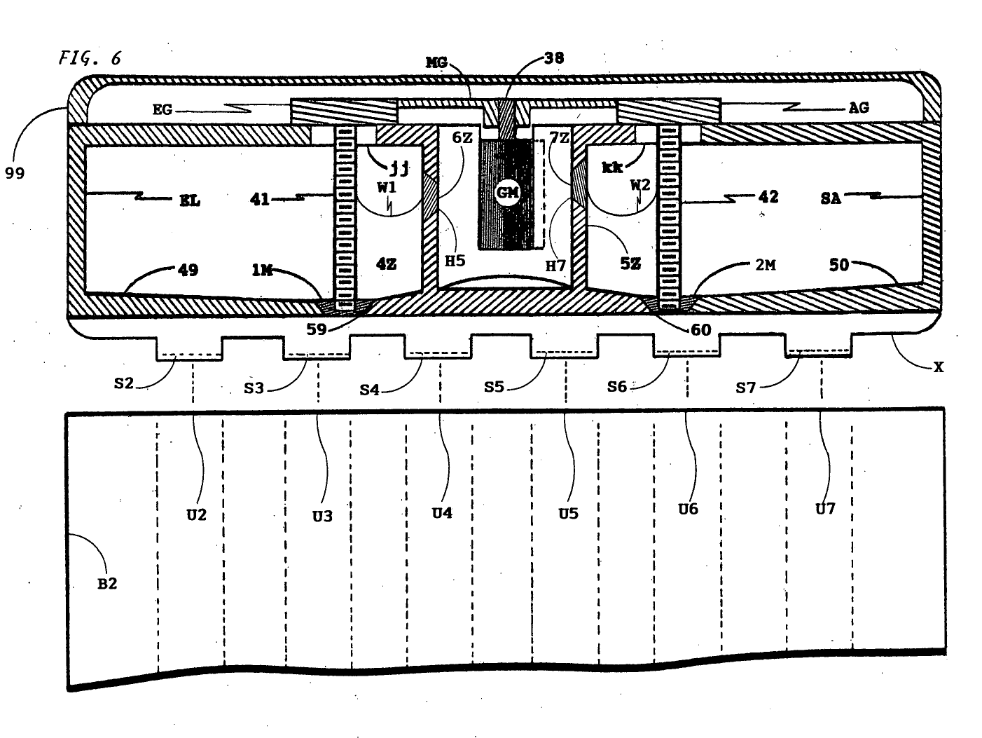

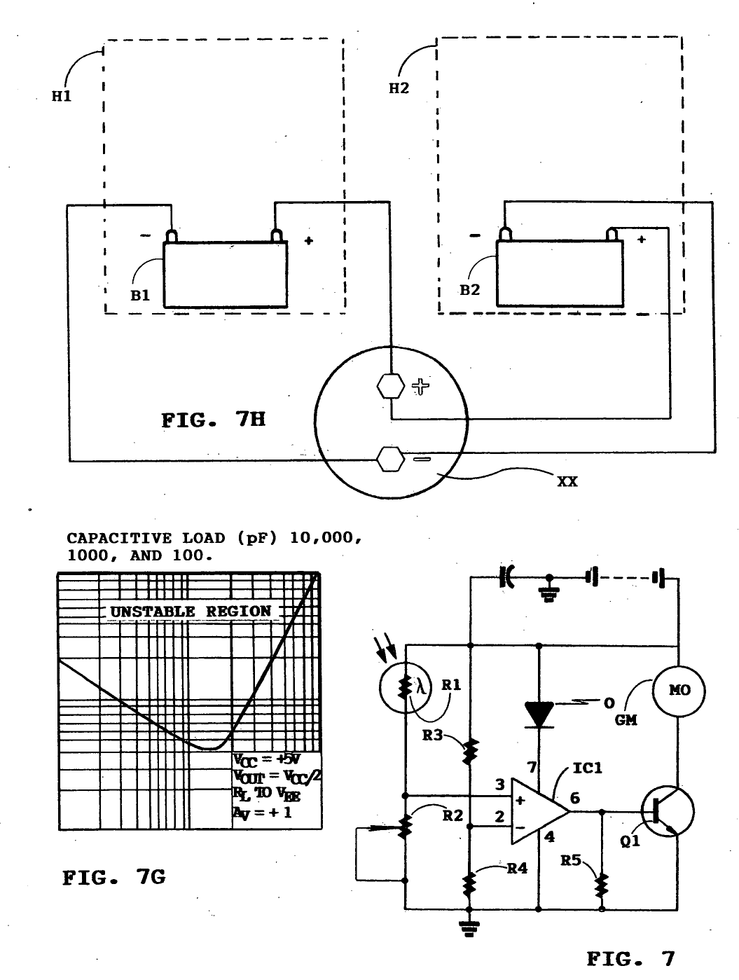

Referring to FIGS. 5-6, the chargers H1-H2 have dual battery cartridges 98 to 99 for renewing battery life to the batteries B1 and B2. As shown in FIG. 7, a light activating drive circuit Z1 controls a gear motor GM that is positioned in the cartridge 98. The circuit Z1 is also included in the cartridge 99 for activating another gear motor GM, which has a gear MG about a shift 38, and is actuated by a CMOS op amp IC1. Notwithstanding, the IC1 is used as a voltage comparator, which scans the levels of two input voltages, and turns its output on, or off based on, which input voltage is more. The input of pin 2 is fixed to a reference voltage of almost half the supply voltage by R3-R4, when the input on pin 3 is connected to a voltage divider R1, and one potentiometer R2. The resistance about a photocell changes, as the LED 0 emits light, the light intensity is thereby, indicatively shown by the voltage on pin 3 of IC1. The light level which turns on this circuit is set by R2. The output of pin 6 is turned on via R5, when the voltage about pin 3 of IC1 is more than pin 2. The output of IC1 drives a transistor Q1 so the transistor Q1 turns the gear motor GM on, and off by the op amp.

As this LED 0 starts the motor GM, the motor gear MG is rotated clockwise, such, as to rotate an Electrolyte gear EG, and a Sulphuric Acid gear AG counter clockwise. This is performed simultaneously since the gear MG is placed between both gears EG, and AG so that two cone shaped plugs 1M to 2M are rotated upward from two drain holes 39-40. The plugs 1M and 2M are secured, below two helixes 41-42. Two perforated blocks jj-kk having internal screw thread for receiving each helix 41-42. The gear EG is secured about the helix 41, and the gear AG is secured upon the helix 42. The cartridges 98 and 99 have two tubs, namely, EL and SA. The tubs EL and SA are divided by two walls 4Z-5Z. The wall 4Z includes a plug 6Z in its hole H6, and the wall 5Z defines a plug 7Z, in its hole H7, so that the plug 6Z is connected to the helix 41 by a wire W1, and the plug 7Z is connected to the helix 42 by a wire W2. As a result, when the LED 0 turns on the motor GM, as the gear MG is rotated clockwise, the plugs 6Z-7Z each of which is yanked from the holes H6-H7 by the wires W1-W2. As the plugs 6Z-7Z are jerked by the wires W1-W2, the Sulphuric Acid, and the Electrolyte flows through the walls 4Z-5Z such that the Electrolyte can dissolve accordingly.

The nonmetallic electric conductor Electrolyte about which current is carried on an atom, as ion, or the movement of ions occupies the tub EL. Besides, this atom ion carries a positive, or negative electric charge which is a result of having lost or gained one or more electrons. Electrolyte is a substance so that when dissolved in Sulphuric Acid becomes a fused ionic conductor. Thus, this Sulphuric Acid occupies the tub labeled SA.

Now, both floor surfaces 49-50 define an acute angle so that the Electrolyte, and the Acid can drain smoothly via the drain holes 39-40, thus, into a six cell feeder F6. The six cell feeder having six internal seals for preventing the Electrolyte, and the Acid from draining in the batteries B1-B2 before being appropriately dissolved. When the Acid, and the Electrolyte are defined, as a fused ionic conductor, the six seals will breakdown such that the fused ionic conductor will penetrate each seal. Upon penetration, the six battery cells of B1-B2 are replenished, seeing six extended portions below the feeder F6 are shaped to conform to the contours of each cell. Now, this generates the voltage in the batteries B1-B2 to a fully-charged voltage status about modification.

The batteries B1-B2 each of which is not as heavy as a lead storage cell, and has a longer life. These batteries B1-B2 requires less attention, and care, as they can be completely discharged and left uncharged for an indefinite time period. This abusive treatment would ruin a lead cell. Now when the internal resistance via the batteries B1-B2 each of which is defined by having very little resistance, and their life expectancies are near, the LED 0 can emit light about a dashboard (FIG. 7F). The cartridges 98-99 each of which can extend by cutouts 3B-3C of the chargers H1-H2. The lower end portions of the cartridges 98-99 will fit two cutouts 5C-6C, thus, in two battery charging housings H1-H2.

I claim:

1. A pair of cordless battery operated actuating chargers activating one another in a vehicle, other vehicles and performing said activation of other devices, comprising:
a first 2.5 A battery charger, thereby, defining 96 percent efficiency;
a second 2.5 A battery charger, thereby having said 96 percent efficiency also;
a power switch mounted upon said first charger for placement of a user's finger, thereby, activated by pressing a surface of said switch for actuating said chargers simultaneously, said switch is set on a column for actuating said vehicle also;
a buck-mode switching regulator (IC1) for, thereby controlling said exterior power switch; said IC1 defining a charge pump for generating a positive gate-drive voltage required by said switch;
a battery-charging current having a voltage across a 25-ohms resistor (R3), and is amplified via an op amp, thereby including positive-voltage feedback to said IC1;
a chip for maintaining said charging current at 2.5 A;
a circuit for supplying said current to a separate load up to a limit set, thereby, a current-sense transformer (T1) including a sense resistor (R1) thereby improving efficiency, and lowering power dissipation in said resistor R1 when charging;

2. A pair of energy chargers as defined in claim 1, wherein said transformer T1 turns ratio (1:70) routes only 1/70 via the total battery-plus-load current through said resistor R1.

3. A pair of energy chargers as defined in claim 1, wherein said transformer T1 has said voltage feed-back to let said IC1 limit the overall current to a level compatible by the outer components and a 100 mV current-limit threshold.

4. A pair of cordless battery operated actuating chargers activating one another in a vehicle, other vehicles and performing said activation of other devices, comprising:
a first DC-AC converter for converting DC current to alternating current;
a second DC to AC converter for converting said DC current to said alternating current;
a first AC adaptor for connecting said chargers to said converters;
a second AC adaptor for joining said chargers with said converters, when said chargers having full-charged energy:
actuating one another by a conventional switch;
a first battery cartridge for restoring life about a first battery;
a second battery cartridge for restoring said life of a second battery;
a six cell feeder for distributing renewable agents to said first battery, and
a six cell feeder for distributing renewable agents to said second battery.

5. A pair of energy chargers as defined in claim 4, wherein said vehicle having a motor mounted adjacent said chargers.

6. A pair of energy chargers as defined in claim 4, wherein said motor comprises a polarized plug.

7. A pair of energy chargers as defined in claim 4, wherein said chargers performing said activation of said motor, when said plug is connected to said first converter.

8. A pair of energy chargers as defined in claim 4, wherein said chargers performing said activation of said motor, thereby starting said vehicle.

9. A pair of energy chargers as defined in claim 4, wherein said batteries are joined about an alternator for its belt, and pulley to spin (60 cps/60 Hz) via said motor.

10. A pair of energy chargers as defined in claim 4, wherein said chargers, thereby performing said activation of said motor, when activating one another.

11. A pair of energy chargers as defined in claim 4, wherein said chargers, thereby performing said activation of one another, when said motor is turned off.

12. A pair of energy chargers as defined in claim 4, wherein said chargers activate said other vehicles in the air, upon the earth, and in the water.

13. A pair of energy chargers as defined in claim 4, wherein said chargers, thereby performing said activation about said other devices, in homes, condominiums, Hospitals, Air Ports, offices, housings, and Generating Stations.

14. A pair of energy chargers as defined in claim 4, wherein said chargers, thereby actuating computers, televisions, electric ranges, air conditioners, and all portable devices about radios, CD players including refrigerators.

15. A pair of energy chargers as defined in claim 4, wherein said chargers, thereby actuating cordless escalators at Air Ports, and Train stations.

16. A pair of energy chargers as defined in claim 4, wherein said chargers activating snow removal equipment, fire fighting equipment and motorized wheelchairs.

17. A pair of energy chargers as defined in claim 4, wherein said chargers, thereby performing said activation of satellites, and systems for interception of missals.

18. A pair of energy chargers as defined in claim 4, wherein said chargers connected about series-parallel are equal to the sum of the power values consumed via each load.

19. A pair of energy chargers as defined in claim 4, wherein said cartridges including a LED and resistors for actuating a first-second gear motor, battery life is renewed when said gear motors free said renewable agents.

20. A pair of energy chargers as defined in claim 4, wherein said chargers, thereby activate backup systems to prevent the loss of data about computers.
